(19) United States
(12) Patent Application Publication
(10) Pub. No.: US 2015/0228382 A1
(43) Pub. Date: Aug. 13, 2015

(54) METHOD FOR FORMING CONDUCTOR IN MINUTE SPACE

(71) Applicant: NAPRA CO., LTD., Tokyo (JP)

(72) Inventors: Shigenobu Sekine, Tokyo (JP); Keiji Okada, Tokyo (JP)

(73) Assignee: NAPRA CO., LTD., Tokyo (JP)

(21) Appl. No.: 14/552,878

(22) Filed: Nov. 25, 2014

(30) Foreign Application Priority Data
Feb. 13, 2014 (JP) 2014-025116

(51) Int. Cl. H01B 13/32; H01B 1/22; C09D 5/24; B05D 3/02

(52) U.S. Cl. CPC H01B 13/321; B05D 3/0254; H01B 1/22; C09D 5/24; B05D 2259/00

(57) ABSTRACT

A method for forming a conductor in a minute space of an object includes the steps of filling a first metallic material into the minute space, the first metallic material being composed of particles and dispersed in a liquid dispersion medium; evaporating the liquid dispersion medium inside the minute space; and feeding a second metallic material into the minute space, wherein the first and second metallic materials, in combination, include a combination of a high-melting metallic material and a low-melting metallic material.

### BACKGROUND OF THE INVENTION

1. Field of the Invention

The present invention relates to a method for forming a conductor in a minute space.

2. Description of the Related Art

In electronic devices such as semiconductor devices, micromachines and so on, for example, there may be the case where a fine conductor-filled structure, an insulating structure or a functional structure each having a high aspect ratio must be formed therein. In such a case, there are known technologies for realizing a conductor-filled structure, an insulating structure, a functional structure, etc. by filling a previously chosen filler into a minute hole. However, it is extremely difficult to thoroughly fill a high-aspect-ratio minute hole with a filler down to the bottom thereof without forming a void or causing deformation after hardening.

As a related art capable of overcoming such a technical difficulty, there are known a filling method and device disclosed in Japanese Patent Nos. 4278007 and 4505540.

The technology disclosed in Japanese Patent No. 4278007 is a method for filling a molten metal in a fine hole present in a wafer and hardening it, the method having a step of cooling the molten metal and hardening it while applying a forced external force exceeding atmospheric pressure to the molten metal within the fine hole. The forced external force is given by at least one of a pressing pressure, an injection pressure and a rolling compaction and applied to the molten metal from the side on which the fine hole is open, wherein the other end of the fine hole is closed.

Japanese Patent No. 4505540 discloses a device for implementing the method disclosed in Japanese Patent No. 4278007.

The above-described technologies disclosed in Japanese Patent Nos. 4278007 and 4505540 provide the following excellent effects: the fine hole can be filled with a filler without forming an air gap or void, the metal cooled and hardened within the fine hole can be prevented from having a recessed surface, the process can be simplified and the yield can be improved, and so on.

### SUMMARY OF THE INVENTION

It is an object of the present invention to provide a method for easily forming a conductor that is compact and has a low electrical resistance and high mechanical strength.

In order to attain the above object, the present invention provides a method for forming a conductor in a minute space of an object, comprising the steps of: filling a first metallic material into the minute space, the first metallic material being composed of particles and dispersed in a liquid dispersion medium; evaporating the liquid dispersion medium inside the minute space; and feeding a second metallic material into the minute space. The first and second metallic materials, in combination, include a combination of a high-melting metallic material and a low-melting metallic material.

As described above, since the material (functional material) prepared by dispersing the powdery first metallic material in the liquid dispersion medium is filled into the minute space, although the first metallic material is in the form of powder that is unsuitable for filling in nature, it can be certainly filled into the minute space by exploiting the fluidity of the functional material.

Then, the liquid dispersion medium inside the minute space is evaporated. This results in leaving the powdery first metallic material, i.e., first metallic particles inside the minute space, creating a gap between the first metallic particles.

Then, the second metallic material is fed into the minute space. The first and second metallic materials, in combination, include a combination of a high-melting metallic material and a low-melting metallic material. Therefore, the low-melting metallic material contained in either of the first and second metallic materials can be melted by heating before or after the feeding of the second metallic material. The melted low-melting metallic material is allowed to enter the gap between the first metallic particles, so that a diffusion bond can be formed between the low-melting metallic material and the high-melting metallic particles.

In the production process, therefore, the melting occurs at a low melting point of the low-melting metallic material, but melting after the solidification does not occur below a high melting point of the high-melting metallic particles. This reduces thermal energy consumption during the production process and enables the formation of a thermally stable conductor while reducing thermal damage to semiconductor circuit elements, etc., which may be provided in the object. The high-melting metallic particles form a diffusion bond at the boundary with the low-melting metallic material such that they do not melt and remain largely intact.

The first and second metallic materials, in combination, essentially include a combination of a high-melting metallic material and a low-melting metallic material. The possible combinations are as follows.

(a) First metallic material:

High-melting metallic material

Second metallic material:

Low-melting metallic material

(b) First metallic material:

High-melting metallic material

Second metallic material:

Low-melting metallic material & High-melting metallic material

(c) First metallic material:

High-melting metallic material & Low-melting metallic material

Second metallic material:

Low-melting metallic material

(d) First metallic material:

High-melting metallic material & Low-melting metallic material

Second metallic material:

High-melting metallic material

(e) First metallic material:

High-melting metallic material & Low-melting metallic material

Second metallic material:

Low-melting metallic material & High-melting metallic material

(f) First metallic material:

Low-melting metallic material

Second metallic material:

High-melting metallic material

(g) First metallic material:

Low-melting metallic material

Second metallic material:

High-melting metallic material & Low-melting metallic material

Specific production processes may be as follows.

### (1) Feeding the Second Metallic Material as a Molten Metal

In this case, according to the combination (a), for example, the first metallic material contains a high-melting metallic material, while the second metallic material contains a low-melting metallic material. The second metallic material is fed into the minute space in a molten state.

After the melted low-melting metallic material is fed into the minute space, preferably, it is cooled under pressure for hardening. This allows the melted low-melting metallic material to enter the gap between the high-melting metallic particles, so that a diffusion bond can be formed between the low-melting metallic material and the high-melting metallic particles. The high-melting metallic particles form a diffusion bond at the boundary with the low-melting metallic material such that they do not melt and remain largely intact. In the production process, therefore, the second metallic material can be melted at a low melting point of the low-melting metallic material, but melting after the solidification does not occur below a high melting point of the high-melting metallic particles constituting the first metallic material. This reduces thermal energy consumption during the production process and enables the formation of a thermally stable conductor while reducing thermal damage to semiconductor circuit elements, etc., which may be provided in the object.

Moreover, since the low-melting and high-melting metallic materials filled in the minute space are subjected to pressure during the cooling process, the low-melting and high-melting metallic materials can deform or move to follow the contraction due to cooling. This suppresses the formation of gaps or voids.

Alternatively, according to the combination (c), the first metallic material may contain a high-melting metallic material and a low-melting metallic material, while the second metallic material may contain a low-melting metallic material.

Also in this case, the same effects as described above can be expected.

### (2) Feeding the Second Metallic Material as a Metallic Powder

The second metallic material may be fed as a metallic powder. In this case, after the evaporation of the liquid dispersion medium inside the minute space, the second metallic material is fed into the minute space and then heated. This melts low-melting metallic particles contained in either of the first and second metallic materials, and the melted low-melting metallic material is allowed to enter the gap between high-melting metallic particles contained in either of the first and second metallic materials, so that a diffusion bond can be formed between the low-melting metallic material and the high-melting metallic particles. In the production process, therefore, the melting occurs at a low melting point of the low-melting metallic material, but melting after the solidification does not occur below a high melting point of the high-melting metallic particles. This reduces thermal energy consumption during the production process and enables the formation of a thermally stable conductor while reducing thermal damage to semiconductor circuit elements, etc., which may be provided in the object.

Moreover, since the low-melting and high-melting metallic materials filled in the minute space are subjected to pressure during the cooling process, the low-melting and high-melting metallic materials can deform or move to follow the contraction due to cooling. This suppresses the formation of gaps or voids.

### (3) Feeding the Second Metallic Material as a Metallic Film

The second metallic material may also be fed as a metallic film. (4) Definitions

The term “dispersion” as used herein refers to a suspension or paste in which fine solid particles are dispersed in a liquid dispersion medium, including both systems: a monodisperse system in which all the particles have a uniform particle size; a polydisperse system in which the particle size is not uniform. Moreover, it includes not only a coarse dispersion but also a colloidal dispersion. The liquid dispersion medium is an aqueous dispersion medium or a volatile organic dispersion medium.

Throughout the description, the first metallic material and the second metallic material are not limited to a single metallic element but may contain two or more metallic elements.

Specifically, the high-melting metallic material may be a metallic or alloy material containing at least one element selected from the group consisting of Ag, Cu, Au, Pt, Ti, Zn, Al, Fe, Si and Ni. The high-melting metallic material is preferably composed of nm-sized nanoparticles (1 μm or less) or particles having a nanocomposite structure.

The low-melting metallic material may contain at least one metal selected from the group consisting of Sn, Bi, Ga and In or an alloy thereof.

The low-melting metallic material is also preferably composed of nanoparticles or particles having a nanocomposite structure.

The low-melting metallic particles and the high-melting metallic particles may have different particle sizes or a uniform particle size. They may also have any shape such as a spherical shape, a scale shape, a flat shape, etc.

As has been described above, the present invention provides a method for forming a functional part free from a void, gap or hollow in a minute space of an object.

The present invention will be more fully understood from the detailed description given hereinbelow and the accompanying drawings which are given by way of illustration only, and thus not to be considered as limiting the present invention.

### BRIEF DESCRIPTION OF THE DRAWINGS

FIG. 1 is a flow chart showing a method according to the present invention.

FIG. 2 is a flow chart showing another method according to the present invention.

FIG. 3 is a flow chart showing still another method according to the present invention.

FIG. 4 is a flow chart showing yet another method according to the present invention.

FIG. 5 is a flow chart showing yet another method according to the present invention.

FIG. 6 is a flow chart showing yet another method according to the present invention.

FIG. 7 is a flow chart showing yet another method according to the present invention.

FIG. 8 is a flow chart showing yet another method according to the present invention.

FIG. 9 is a flow chart showing yet another method according to the present invention.

FIG. 10 is a flow chart showing yet another method according to the present invention.

FIG. 11 is a sectional view of a metallic particle of a first or second metallic material employed for the method according to the present invention.

### DESCRIPTION OF THE PREFERRED EMBODIMENTS

### 1. Feeding the Second Metallic Material as a Molten Metal

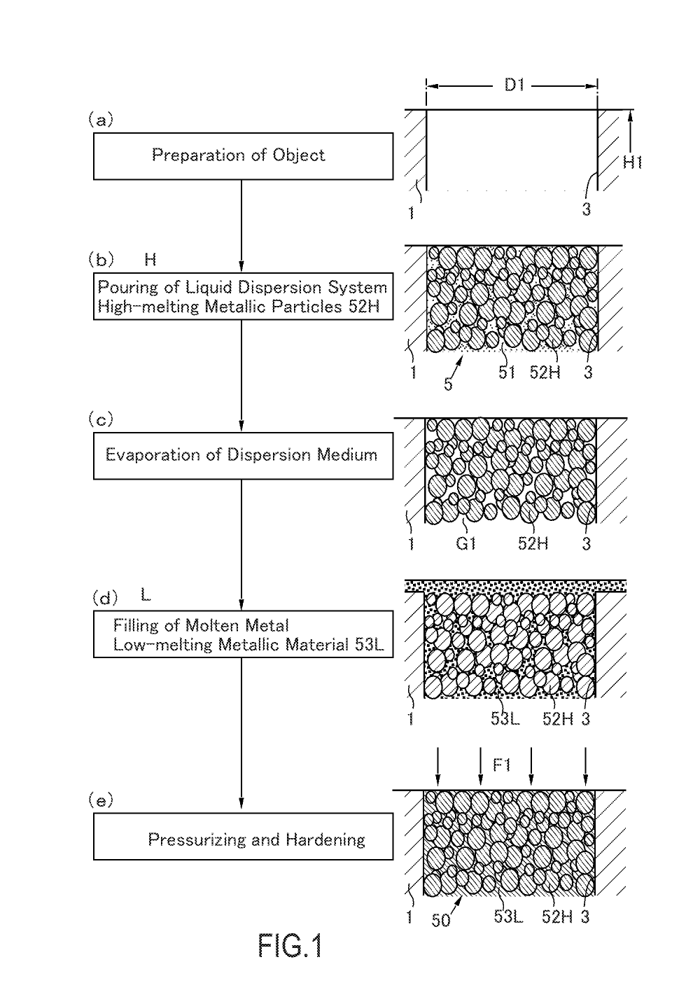

The method shown in FIG. 1 relates to the above-mentioned combination (a). At first, an object 1 having a minute space 3 is prepared (FIG. 1(a)). Examples of the object 1 include various objects having a minute space such as a wafer, a circuit substrate, a multilayer substrate, a semiconductor chip and a MEMS (micro-electro-mechanical systems). The minute space 3 may be not only a through-hole or a non-through-hole (blind hole) represented by a TSV (through silicon via) but also a minute gap formed between stacked substrates or the like. When the object 1 is a semiconductor substrate or the like and has conductivity, the inner wall surface of the minute space 3 may be made of an insulating film or layer.

In the present embodiment, the minute space 3 formed in the object 1 is a through-hole or a non-through-hole having a diameter D1 at the opening end and a depth H1. For example, the diameter D1 is 25 μm or less, while an aspect ratio of the depth H1 to the diameter D1 is 1 or more, preferably 5 or more. When the object 1 is a wafer, for example, a large number of the above-described minute spaces 3 are distributed over the surface of the wafer.

Into the minute space 3 of the above-described object 1, a functional material 5 is filled (poured). The functional material 5 is prepared by dispersing a powdery first metallic material in a liquid dispersion medium 51 (FIG. 1(b)). The powdery first metallic material is composed of the high-melting metallic particles 52H. In order to fill the functional material 5 into the minute space, there may be adopted a filling process using a centrifugal force or a filling process in which ultrasonic vibrations are applied to an object or apparatus.

Preferably, the functional material 5 is filled into the minute space 3 under a reduced-pressure atmosphere within a vacuum chamber. There may be adopted a differential pressure filling process, wherein the internal pressure of the vacuum chamber is increased after the pressure reduction. With this differential pressure filling process, the functional material 5 can be reliably filled into the minute space 3.

Then, the liquid dispersion medium 51 inside the minute space 3 is evaporated (FIG. 1(c)). Thus, a gap G1 is created between the high-melting metallic particles 52H.

Then, the melted low-melting metallic material 53L is fed into the minute space 3 as the second metallic material (FIG. 1(d)) and hardened by cooling under pressure F1 (FIG. 1(e)). This allows the melted low-melting metallic material 53L to enter the gap G1 between the high-melting metallic particles 52H (FIG. 1(d)), providing a conductor 50 in which a diffusion bond is formed between the low-melting metallic material 53L and the high-melting metallic particles 52H. The high-melting metallic particles 52H form a diffusion bond at the boundary with the low-melting metallic material 53L such that they do not melt and remain largely intact.

In the method shown in FIG. 1, as described above, used is the functional material 5 prepared by dispersing the powdery first metallic material in the liquid dispersion medium. That is, the functional material 5 is fluid. Therefore, although the first metallic material is in the form of powder that is unsuitable for filling in nature, it can be certainly filled into the minute space 3 by exploiting the fluidity of the functional material 5, e.g., by means of printing.

Moreover, the gap G1 is created between the high-melting metallic particles 52H by evaporating the liquid dispersion medium 51 inside the minute space 3, and the melted low-melting metallic material 53L is allowed to enter the gap G1 between the high-melting metallic particles 52H, so that a diffusion bond can be formed between the low-melting metallic material 53L and the high-melting metallic particles 52H. The high-melting metallic particles 52H form a diffusion bond at the boundary with the low-melting metallic material 53L such that they do not melt and remain largely intact.

In the production process, therefore, the second metallic material can be melted at a low melting point of the low-melting metallic material 53L, but melting after the solidification does not occur below a high melting point of the high-melting metallic particles 52H constituting the first metallic material. This reduces thermal energy consumption during the production process and enables the formation of a thermally stable conductor 50 while reducing thermal damage to semiconductor circuit elements, etc., which may be provided in the object 1.

Furthermore, since the low-melting metallic material 53L and the high-melting metallic particles 52H filled in the minute space 3 are hardened under pressure Fl during the cooling process, the low-melting metallic and high-melting metallic materials can deform or move to follow the contraction due to cooling. This suppresses the formation of gaps or voids and enables the formation of a low-resistance, highly-reliable, high-quality conductor 50.

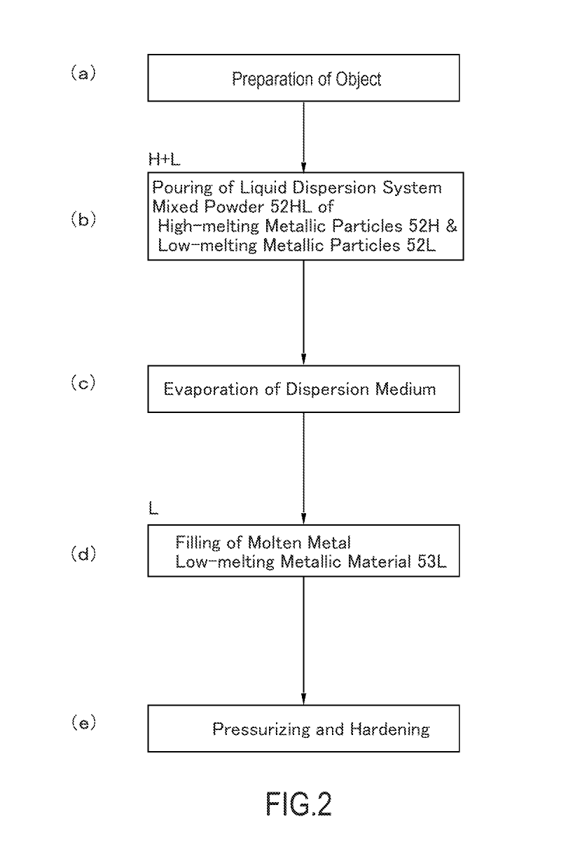

FIG. 2 shows a method relating to the combination (c). In the drawing, the portions corresponding to the components shown in FIG. 1 are denoted by the same reference numbers. At first, a functional material 5 prepared by dispersing a mixed powder 52HL (a mixture of the high-melting metallic particles 52H and low-melting metallic particles 52L) in the liquid dispersion medium 51 is filled into the minute space 3 (FIGS. 2(a) and 2(b)).

Then, after the liquid dispersion medium 51 inside the minute space 3 is evaporated (FIG. 2(c)), the melted low-melting metallic material 53L is fed into the minute space 3 as the second metallic material (FIG. 2(d)) and hardened by cooling under pressure (FIG. 2(e)). Thus, the same effects as in the method illustrated in FIG. 2 can be obtained.

Although not described in detail, when feeding the second metallic material as a molten metal, the combination of the first and second metallic materials may be (b), (e) or (g) instead.

### 2. Feeding the Second Metallic Material as a Metallic Powder

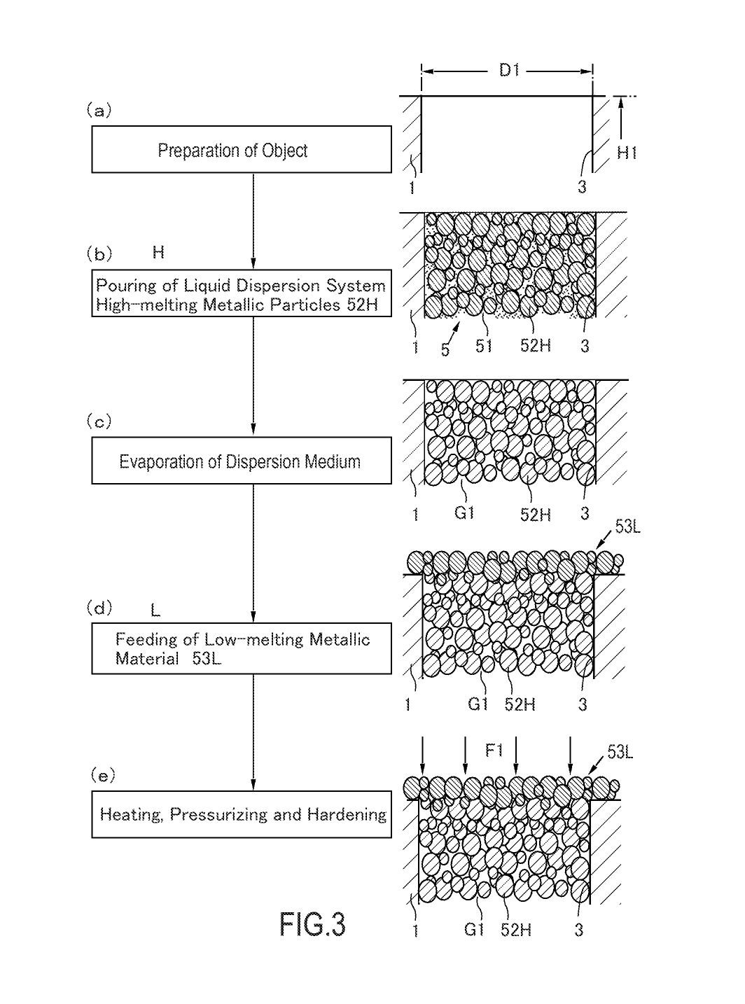

FIG. 3 shows another method. In the drawing, the portions corresponding to the components shown in FIG. 1 are denoted by the same reference numbers. In this method, the combination of the first and second metallic materials is (a). The process shown in FIGS. 3(a) to 3(c) is identical to that shown in FIGS. 1(a) to 1(c), and the same effects can be obtained.

In FIG. 3, what is characteristic is that after the liquid dispersion medium 51 inside the minute space 3 is evaporated, the powdery low-melting metallic material 53L is fed into the minute space 3 (FIG. 3(d)), followed by heating, pressurizing and hardening (FIG. 3(e)). By heating the low-melting metallic material 53L fed into the minute space 3 after the evaporation of the liquid dispersion medium 51 inside the minute space 3, the low-melting metallic material 53L can be melted to enter the gap G1 between the high-melting metallic particles 52H, so that a diffusion bond can be formed between the low-melting metallic material 53L and the high-melting metallic particles 52H.

In the production process, therefore, the second metallic material can be melted at a low melting point of the low-melting metallic material 53L, forming a diffusion bond with the first metallic material, but melting after the solidification does not occur below a high melting point of the high-melting metallic particles 52H constituting the first metallic material.

This reduces thermal energy consumption during the production process and enables the formation of a thermally stable conductor 50 while reducing thermal damage to semiconductor circuit elements, etc., which may be provided in the object 1.

In the process of heating, pressurizing and hardening the low-melting metallic material 53L fed into the minute space 3, moreover, the low-melting metallic material 53L and the high-melting metallic particles 52H filled in the minute space 3 are subjected to pressure F1 during the cooling process, so that the low-melting metallic material 53L and the high-melting metallic material 52 can deform or move to follow the contraction due to cooling. This suppresses the formation of gaps or voids and enables the formation of a low-resistance, highly-reliable, high-quality conductor 50.

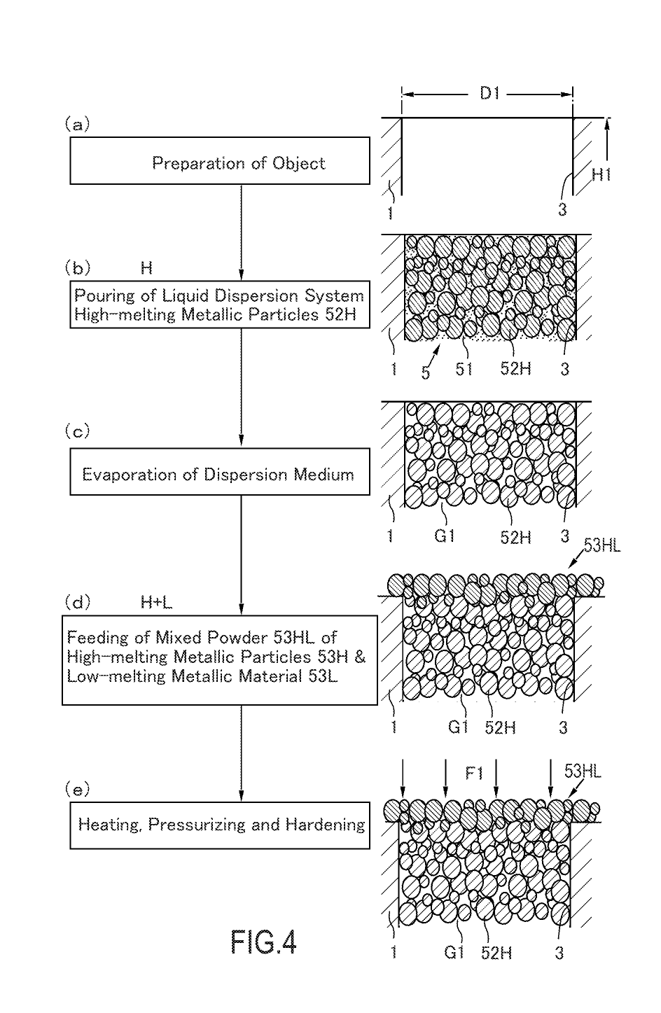

In the embodiment shown in FIG. 4, the combination of the first and second metallic materials is (b). At first, the functional material 5 prepared by dispersing the powdery high-melting metallic material 52H (the first metallic material) in the liquid dispersion medium 51 is filled into the minute space 3 (FIGS. 4(a) and 4(b)). Then, after the evaporation of the liquid dispersion medium 51 inside the minute space 3 (FIG. 4(c)), a mixed powder 53HL prepared by mixing the high-melting metallic particles 53H and the low-melting metallic particles 53L is fed into the minute space 3 as the second metallic material (FIG. 4(d)), followed by heating, pressurizing F1 and hardening (FIG. 4(e)).

According to this process, the same effects as in the method illustrated in FIG. 3 can be obtained.

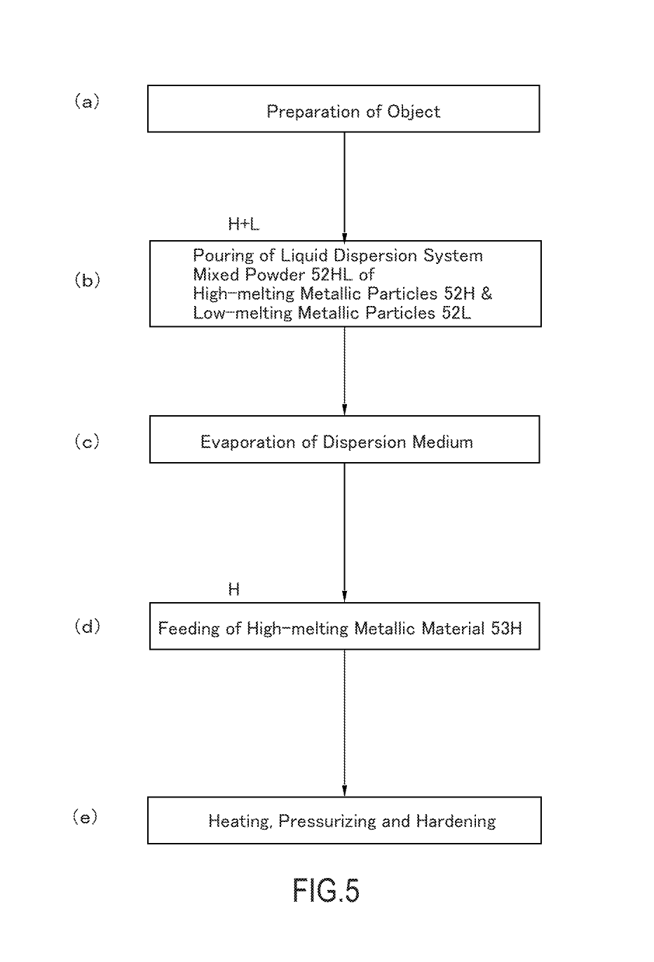

In the embodiment shown in FIG. 5, the combination of the first and second metallic materials is (d). As the first metallic material, at first, the mixed powder 52HL is prepared by mixing the high-melting metallic particles 52H and the low-melting metallic particles 52L. A functional material prepared by dispersing the first metallic material in the liquid dispersion medium 51 is filled into the minute space (FIGS. 5(a) to 5(b)). Then, after the evaporation of the liquid dispersion medium inside the minute space (FIG. 5(c)), as shown in FIGS. 3 and 4, the high-melting metallic particles 53H are fed onto the first metallic material inside the minute space as the second metallic material (FIG. 5(d)), followed by heating, pressurizing F1 and hardening (FIG. 5(e)).

According to the above process, the low-melting metallic particles 52L contained in the first metallic material can be melted, so that a diffusion bond can be formed between the low-melting metallic particles 52L and the high-melting metallic particles 52H contained in the first metallic material and the high-melting metallic particles 53H constituting the second metallic material. Therefore, the same effects as in the method illustrated in FIGS. 3 and 4 can be obtained.

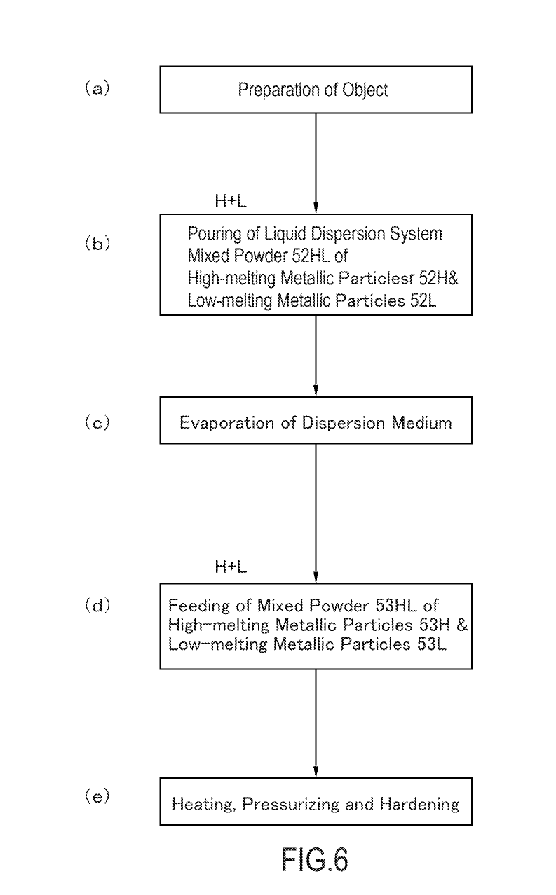

In the embodiment shown in FIG. 6, the combination of the first and second metallic materials is (e). As the first metallic material, at first, the mixed powder 52HL is prepared by mixing the high-melting metallic particles 52H and the low-melting metallic particles 52L. A functional material prepared by dispersing the first metallic material in the liquid dispersion medium is filled into the minute space (FIGS. 6(a) to 6(b)). Then, after the evaporation of the liquid dispersion medium inside the minute space (FIG. 6(c)), as shown in FIGS. 3 and 4, the second metallic material is fed onto the first metallic material inside the minute space (FIG. 6(d)), followed by heating, pressurizing F1 and hardening (FIG. 6(e)). The second metallic material is the mixed powder 53HL prepared by mixing the high-melting metallic particles 53H and the low-melting metallic particles 53L.

According to the above process, the low-melting metallic particles 52L and 53L contained in the first and second metallic materials can be melted, so that a diffusion bond can be formed between the low-melting metallic particles 52L and 53L and the high-melting metallic particles 52H contained in the first metallic material and the high-melting metallic particles 53H contained in the second metallic material. Therefore, the same effects as in the method illustrated in FIGS. 3 and 4 can be obtained.

### 3. Feeding the Second Metallic Material in the Form of a Film

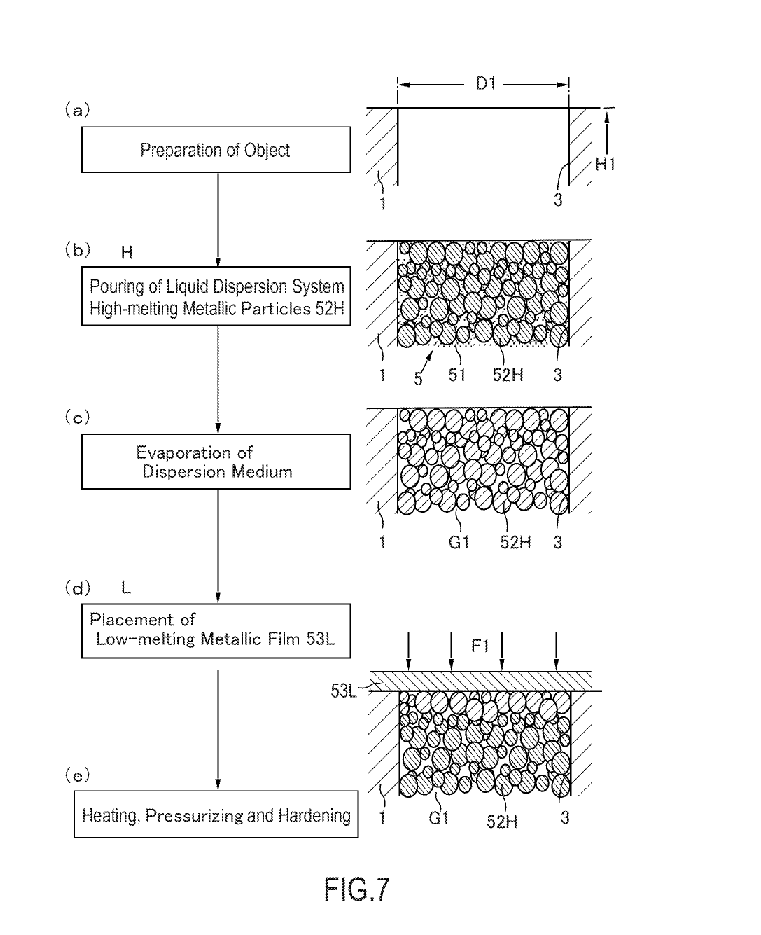

In the method shown in FIG. 7, the combination of the first and second metallic materials is (a). That is, the first metallic material is high-melting metallic particles 52H serving as the high-melting metallic material, while the second metallic material is a low-melting metallic film 53L serving as the low-melting metallic material.

In order to form a conductor inside the minute space 3, at first, the functional material 5 prepared by dispersing the high-melting metallic particles 52H in the liquid dispersion medium 51 is filled into the minute space 3, and then, the liquid dispersion medium 51 inside the minute space 3 is evaporated (FIGS. 7(a) to 7(c)).

Then, after the evaporation of the liquid dispersion medium 51 inside the minute space 3, the low-melting metallic film 53L in the form of a thin film is placed over the region containing the opening of the minute space 3 (FIG. 7(d)), followed by heating, pressurizing and hardening.

By heating the low-melting metallic film 53L placed over the region containing the opening of the minute space 3 after the evaporation of the liquid dispersion medium 51 inside the minute space 3, as described above, the low-melting metallic film 53L can be melted, so that a diffusion bond can be formed between the melted low-melting metallic material 53L and the high-melting metallic particles 52H.

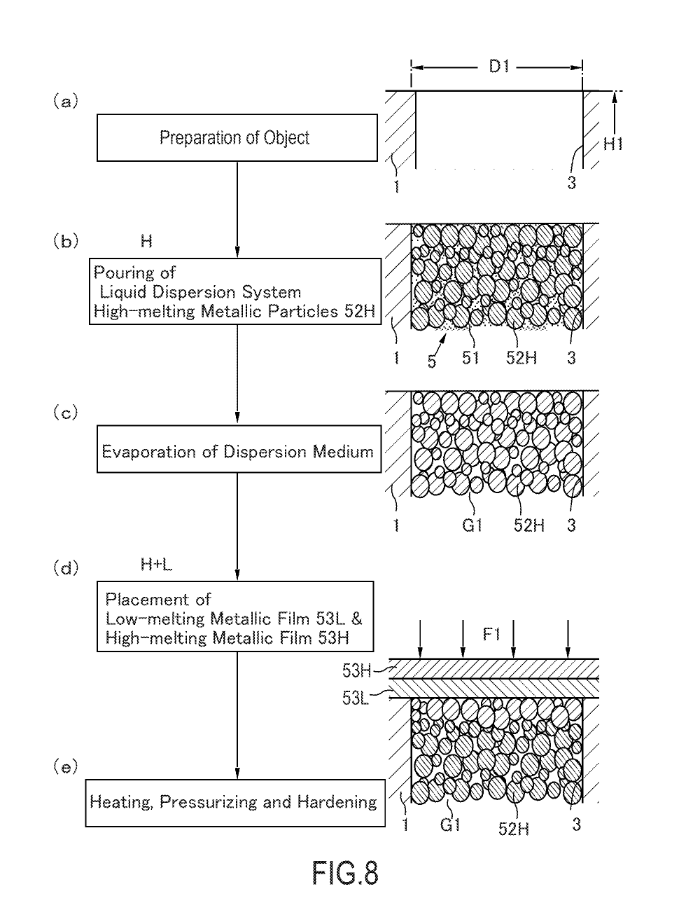

In the method shown in FIG. 8, the combination of the first and second metallic materials is (b). That is, the first metallic material is high-melting metallic particles 52H serving as the high-melting metallic material, while the second metallic material is a combination of a low-melting metallic film 53L serving as the low-melting metallic material and a high-melting metallic film 53H serving as the high-melting metallic material.

In order to form a conductor inside the minute space 3, at first, the functional material 5 prepared by dispersing the high-melting metallic particles 52H in the liquid dispersion medium 51 is filled into the minute space 3, and then, the liquid dispersion medium 51 inside the minute space 3 is evaporated (FIGS. 8(a) to 8(c)).

Then, after the evaporation of the liquid dispersion medium 51 inside the minute space 3, the low-melting metallic film 53L and the high-melting metallic film 53H stacked in the named order over the region containing the opening of the minute space 3 (FIG. 8(d)), followed by heating, pressurizing and hardening.

By heating the low-melting metallic film 53L and the high-melting metallic film 53H stacked over the region containing the opening of the minute space 3 after the evaporation of the liquid dispersion medium 51 inside the minute space 3, as described above, the low-melting metallic film 53L can be melted, so that a diffusion bond can be formed between the melted low-melting metallic material 53L and the high-melting metallic particles 52H and the high-melting metallic film 53H.

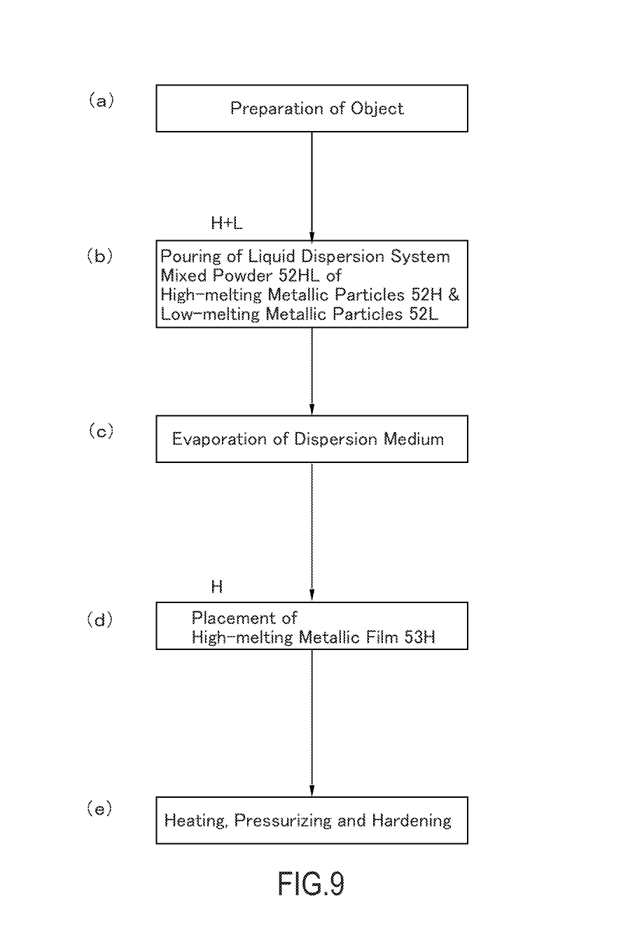

In the method shown in FIG. 9, the combination of the first and second metallic materials is (d). That is, the first metallic material is the mixed powder 52HL prepared by mixing the high-melting metallic particles 52H and the low-melting metallic particles 52L, while the second metallic material is a high-melting metallic film 53H serving as the high-melting metallic material.

In order to form a conductor inside the minute space 3, at first, the functional material prepared by dispersing the mixed powder 52HL in the liquid dispersion medium is filled into the minute space, and then, the liquid dispersion medium inside the minute space is evaporated (FIGS. 9(a) to 9(c)).

Then, after the evaporation of the liquid dispersion medium inside the minute space, the high-melting metallic film 53H is placed over the region containing the opening of the minute space (FIG. 9(d)), followed by heating, pressurizing and hardening.

By heating the high-melting metallic film 53H placed over the region containing the opening of the minute space 3 after the evaporation of the liquid dispersion medium 51 inside the minute space 3, as described above, the low-melting metallic particles 52L of the first metallic material can be melted, so that a diffusion bond can be formed between the melted low-melting metallic material 52L and the high-melting metallic particles 52H and the high-melting metallic film 53H.

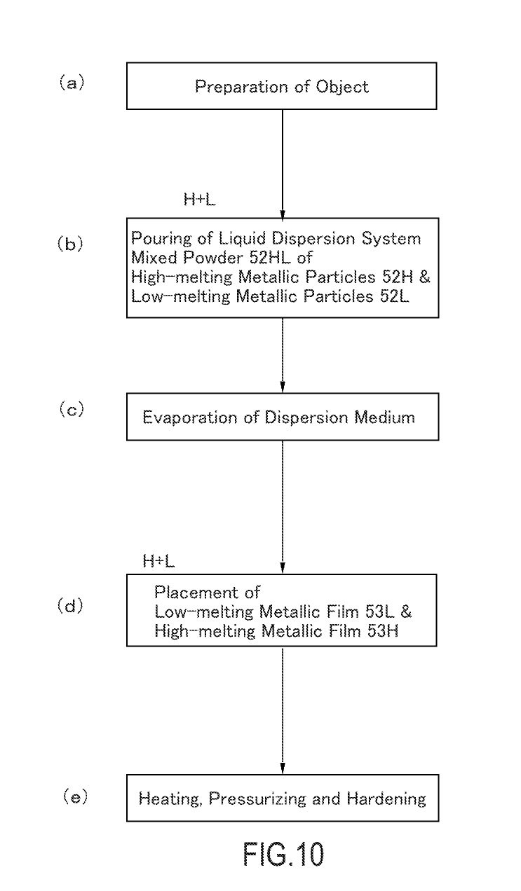

In the method shown in FIG. 10, the combination of the first and second metallic materials is (e). That is, the first metallic material is the mixed powder 52HL prepared by mixing the high-melting metallic particles 52H and the low-melting metallic particles 52L, while the second metallic material is a stack of the low-melting metallic film 53L and the high-melting metallic film 53H, as shown in FIG. 8.

In order to form a conductor inside the minute space, at first, the functional material prepared by dispersing the mixed powder 52HL in the liquid dispersion medium is filled into the minute space, and then, the liquid dispersion medium inside the minute space is evaporated (FIGS. 10(a) to 10(c)).

Then, after the evaporation of the liquid dispersion medium inside the minute space, the low-melting metallic film 53L and the high-melting metallic film 53H are stacked over the region containing the opening of the minute space (FIG. 9(d)), followed by heating, pressurizing and hardening.

By heating the low-melting metallic film 53L and the high-melting metallic film 53H stacked over the region containing the opening of the minute space 3 after the evaporation of the liquid dispersion medium 51 inside the minute space 3, as described above, the low-melting metallic particles 52L of the first metallic material and the low-melting metallic film 53L of the second metallic material can be melted, so that a diffusion bond can be formed between the melted low-melting metallic materials 52L and 53L and the high-melting metallic particles 52H and the high-melting metallic film 53H.

Also in the embodiments shown in FIGS. 7 to 10, the following effects can be obtained.

First of all, since the functional material 5 is a fluid filler, although the first metallic material is in the form of powder that is unsuitable for filling in nature, it can be certainly filled into the minute space 3 by exploiting the fluidity of the functional material 5, e.g., by means of printing.

Moreover, the formation of the diffusion bond between the melted low-melting metallic material and the high-melting metallic material reduces thermal energy consumption during the production process and enables the formation of a thermally stable conductor 50 while reducing thermal damage to semiconductor circuit elements, etc., which may be provided in the object.

Furthermore, since the low-melting metallic material and the high-melting metallic particles filled in the minute space 3 are hardened under pressure during the cooling process, the low-melting and high-melting metallic materials can deform or move to follow the contraction due to cooling. This suppresses the formation of gaps or voids and enables the formation of a low-resistance, highly-reliable, high-quality conductor 50.

### 4. Structure of the First and Second Metallic Materials

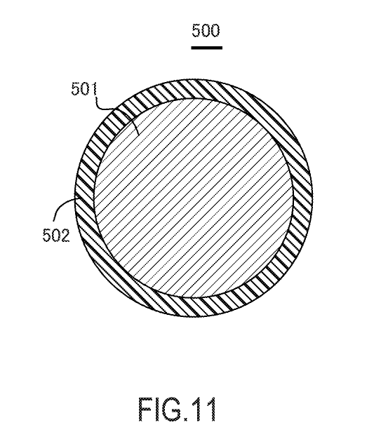

The first and second metallic materials are preferably composed of metallic particles covered with a resin film. This is because the resin-coated metallic particles can prevent oxidation and aggregation. FIG. 11 shows its schematic view. Referring to FIG. 11, a metallic particle 500 comprises a metal core (low-melting or high-melting metal particle) 501 covered with a resin film 502. The metal core 501 has a nanocomposite structure. The metal cores 501 may have different particle sizes or a uniform particle size. They may also have any shape such as a spherical shape, a scale shape, a flat shape, etc. The resin film 502 serves as an antioxidant film and as an anti-aggregation film. Such a technology is disclosed, for example, in Japanese Unexamined Patent Application Publication No. 2006-22384.

In Japanese Unexamined Patent Application Publication No. 2006-22384, the resin-coated metallic particles in which the surface of each metallic particle is coated with a resin layer are produced as follows. As the metallic particles, the ones having polymerizable reactive groups on each surface obtained by reacting metallic particles surface-treated with a triazine-thiol compound and an organic compound having polymerizable reactive groups and capable of reacting with a triazine-thiol compound are used, and resin coating is performed by the polymerization between the metallic particles having polymerizable reactive groups on each surface and a polymerizable monomer.

The metallic particles 500 thus covered with the resin film 502 are dispersed in an aqueous dispersion medium or a volatile organic dispersion medium so as to form a functional material.

However, the resin-coated metallic particles in which the surface of each metal particle is coated with a resin layer and the production method thereof is not limited to the one disclosed in Japanese Unexamined Patent

Application Publication No. 2006-22384. Various types of metallic particles including well known ones or ones that may be proposed in the future may also be employed. For example, it is expected that a certain type of hydride is also applicable.

While the present invention has been particularly shown and described with respect to preferred embodiments thereof, it will be understood by those skilled in the art that various changes in form and detail may be made therein without departing from the spirit, scope and teaching of the invention.

What is claimed is:

1. A method for forming a conductor in a minute space of an object, comprising the steps of:
filling a first metallic material into the minute space, the first metallic material being composed of particles and dispersed in a liquid dispersion medium;
evaporating the liquid dispersion medium inside the minute space; and
feeding a second metallic material into the minute space, wherein the first and second metallic materials, in combination, include a combination of a high-melting metallic material and a low-melting metallic material.

2. The method of claim 1, wherein the first metallic material includes the high-melting metallic material, and the second metallic material includes the low-melting metallic material and is fed into the minute space in a molten state.

3. The method of claim 1, wherein the first metallic material includes at least one of the high-melting metallic material or the low-melting metallic material, and the second metallic material includes at least one of the low-melting metallic material or the high-melting metallic material and is heated after the feeding into the minute space.

4. The method of claim 3, wherein the second metallic material is fed as a powder or a metallic film.

5. A functional material comprising metallic particles dispersed in a dispersion medium, the metallic particles having metal cores covered with a resin film, the dispersion medium being an aqueous dispersion medium or a volatile organic dispersion medium.
